(19) United States
(12) Patent Application Publication
(10) Pub. No.: US 2004/0145859 A1
(43) Pub. Date: Jul. 29, 2004

(54) Acoustic device

(75) Inventor: Niro Nakamichi, Tokyo (JP)

Correspondence Address: DARBY & DARBY P.C., P. O. BOX 5257, NEW YORK, NY, 10150-5257, US

(73) Assignee: MECHANICAL RESEARCH CORP., Tokyo (JP)

(21) Appl. No.: 10/717,274

(22) Filed: Nov. 18, 2003

Related U.S. Application Data
(62) Division of application No. 09/705,496, filed on Nov. 3, 2000.

(30) Foreign Application Priority Data
Nov. 4, 1999 (JP) 11-313973
Nov. 4, 1999 (JP) 11-313974
Nov. 4, 1999 (JP) 11-313975
Nov. 4, 1999 (JP) 11-313976
Nov. 8, 1999 (JP) 11-317515
Dec. 7, 1999 (JP) 11-347012
Dec. 20, 1999 (JP) 11-360124

(51) Int. Cl. H02B 1/00

(52) U.S. Cl. 361/600

(57) ABSTRACT

A circular audio amplifier positions the weighty components of its power supply at the bottom, and the audio amplifier portions at the top. Modular finned heat sinks about the audio amplifier portions are resiliently mounted to reduce the transmission of vibration therefrom into the audio amplifier portions. Each module of the heat sink includes copper wires spanning its vertical dimension to short out induced current from top to bottom of the relatively poor electrical conduction of the aluminum of which the heat sinks are made. The audio amplifier portions, except for the final amplifiers, are mounted on independently resiliently mounted parallel substrates. The low-signal substrates are mounted the furthest away from the power supply. All cable entries and exits include grooves surrounding them to suppress the entry of electrical interference. Wires between the power supply and the audio amplifier pass through ferrite beads to filter out high-frequency electrical signals.

### BACKGROUND OF THE INVENTION

The present invention relates to an acoustic amplifier.

Conventional acoustic amplifiers generally have a rectangular outer shape with power supply switches and indicators disposed on a front panel and input/output terminals and power supply cables disposed on a rear panel. Heat sinks are formed with a plurality of fins to externally dissipate heat generated by power transistors used for amplification. The heat sinks are disposed inside the amplifier or are disposed on the side panels so that they can be exposed to the outside.

In amplifiers, one factor in minimizing sound quality degradation is to shorten the signal path between the line-in terminal, which is the input terminal, and the speaker terminal, which is the output terminal. Also, superfluous high-frequency noise and vibration from the power supply must be prevented from influencing other elements by separating the stage for amplifying the audio signal from the power supply stage as much as possible.

When the amplifier stage and other circuit stages are laid out on a single substrate, there can be crossover between signal lines and power supply lines that negatively affects sound quality. Thus, the amplifier stage must be spatially separated from the other stages.

### OBJECTS AND SUMMARY OF THE INVENTION

It is an object of the invention to provide an amplifier which overcomes the drawbacks of the prior art.

The amplifier according to the present invention includes: a plurality of substrates disposed roughly parallel to each other in a case; a heat sink formed with a plurality of fins and attached to the case; and an amplifier element attached to the heat sink.

Briefly stated, the present invention provides a circular audio amplifier which positions the weighty components of its power supply at the bottom, and the audio amplifier portions at the top. Modular finned heat sinks about the audio amplifier portions are resiliently mounted to reduce the transmission of vibration therefrom into the audio amplifier portions. Each module of the heat sink includes copper wires spanning its vertical dimension to short out induced current from top to bottom of the relatively poor electrical conduction of the aluminum of which the heat sinks are made. The audio amplifier portions, except for the final amplifiers, are mounted on independently resiliently mounted parallel substrates. The low-signal substrates are mounted the furthest away from the power supply. All cable entries and exits include grooves surrounding them to suppress the entry of electrical interference. Wires between the power supply and the audio amplifier pass through ferrite beads to filter out high-frequency electrical signals.

According to an embodiment of the invention, there is provided an acoustic device comprising: a case, a plurality of substrates disposed in the case, and the plurality of substrates being disposed substantially aligned vertically and roughly parallel to each other.

According to a feature of the invention, there is provided an acoustic device comprising: a housing, a circuit element mounted in the housing, a case on the circuit element, a cover covering a top of the case, an opening disposed on the cover and through which wire passes for connection of the circuit element to other elements in the acoustic device: 8. An acoustic device according to claim 7, further comprising: an attachment member: the attachment member attaching a bottom of the case to the housing.

According to a further feature of the invention, there is provided an acoustic device comprising: at least one connecting member disposed at an outer surface of the acoustic device for providing electrical connection with another device: a groove formed to a predetermined depth about a perimeter of the connecting member at the outer surface: a width and depth of the groove being effective for blocking entry of electrical interference into an interior of the acoustic device.

According to a further feature of the invention, there is provided an acoustic device comprising: a groove formed on the inside of an acoustic device case, at least one wire disposed inside the groove: a cover covering the groove, whereby induction of interference into the at least one wire is prevented.

According to a still further feature of the invention, there is provided an acoustic device comprising: a hollow pipe disposed inside an acoustic device case: at least one wire disposed in the pipe.

According to another feature of the invention, there is provided an acoustic device comprising: a heat sink, the heat sink including a base, at least one power amplifier element affixed to the base: a plurality of fins extending roughly radially from the base.

According to another feature of the invention, there is provided an acoustic device comprising: an electronic part that vibrates when powered is applied thereto, the electronic part being attached to the electronic device via an elastic member to absorb vibration from the electronic part: the elastic member having an elasticity appropriate to a weight of the electronic part.

According to yet another feature of the invention, there is provided an acoustic device comprising: a power supply, the power supply being substantially circular, a transformer in the power supply, a smoothing capacitor in the power supply, the transformer and the smoothing capacitor are disposed along an outer perimeter of the substantially circular power supply.

According to a further feature of the invention, there is provided a power supply for an acoustic device comprising: the power supply being substantially circular, positive power supply parts for a positive power supply, negative power supply parts for a negative power supply, a power transformer, the positive power supply parts, the negative power supply parts, and the transformer are disposed symmetrically relative to an imaginary line forming a central axis of the substantially circular power supply.

The above, and other objects, features and advantages of the present invention will become apparent from the following description read in conjunction with the accompanying drawings, in which like reference numerals designate the same elements.

### BRIEF DESCRIPTION OF THE DRAWINGS

FIG. 1 is a perspective drawing of a power amplifier according to an embodiment of the invention.

FIG. 2 is a vertical cross-section drawing of a transformer of the power amplifier of FIG. 1.

FIG. 3 is a horizontal cross-section drawing of a center sleeve.

FIG. 4 is a perspective drawing of a heat sink as seen from the rear.

FIG. 5 is an exploded drawing of a heat sink of FIG. 4.

FIG. 6 is a perspective drawing with a center sleeve omitted and parts of a power supply and a heat sink cut away.

FIG. 7 is a plan drawing of a ferrite bead support plate.

FIG. 8 is a cross-section drawing of an AC connector bracket.

FIG. 9 is a cross-section drawing of a damper.

FIG. 10 is a top-view drawing of a power amplifier.

FIG. 11 is a vertical cross-section drawing of a transformer to which reference will be made in describing another attachment method for the transformer.

FIG. 12 is a top-view drawing showing the interior of the power supply.

### DETAILED DESCRIPTION OF THE PREFERRED EMBODIMENTS

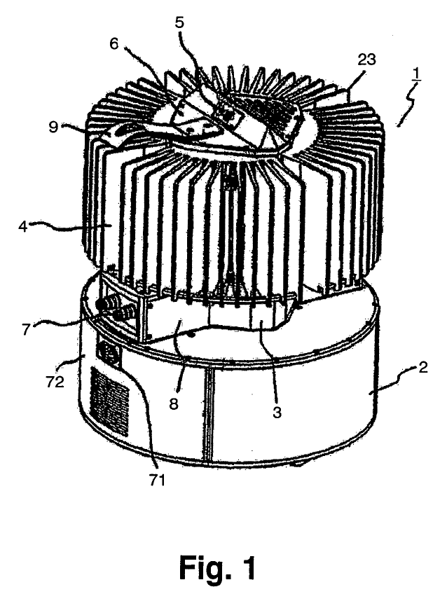

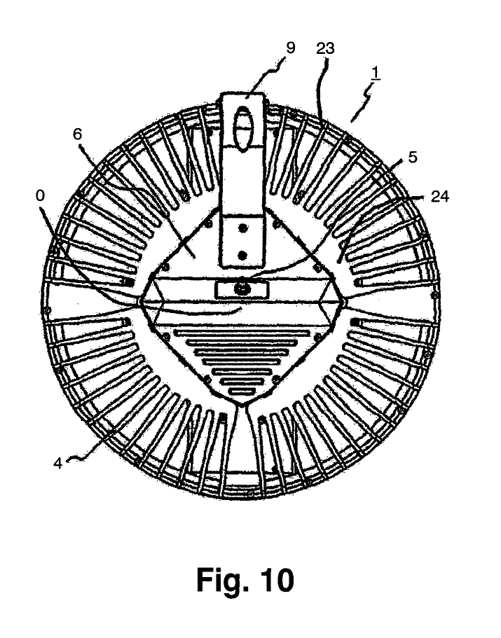

Referring to FIGS. 1 and 10, a monaural audio power amplifier 1 includes a cylindrical power supply 2. Power supply 2 contains conventional components such as, for example, a power supply switch and power-supply circuit elements such as choke coils, capacitors, and power supply transformers for converting 100-120 V alternating current to 10-90 V direct current. Of the circuit parts in the power amplifier 1, these parts relating to the power supply are the heaviest. The power supply components of the power amplifier 1 are placed in the lowest possible position to lower the center of gravity. This improves the stability of the power amplifier 1.

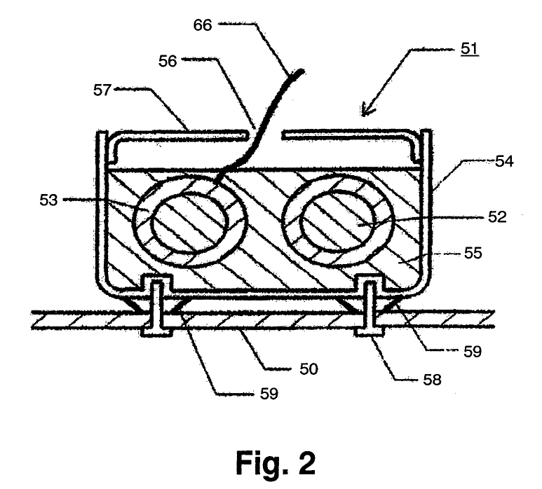

Referring to FIG. 2, a transformer 51 includes a coil 53 wound a predetermined number of times around a core 52. The core 52 is sealed in a case 54 by a filler 55. A cover 57 is attached to the upper part of the case 54. The cover 57 includes an opening 56 to allow the ends 66 of the coil to extend therethrough. Threaded openings in the case 54 accept screws 58 for attaching the case 54 to a bottom base chassis 50. Holes in the bottom base chassis 50, aligned with the threaded openings 54 are unthreaded, and slightly oversized for the screws 58 passing therethrough.

Disc springs 59, having a cone-shaped cross-section, are interposed between the bottom base chassis 50 and the heads of the screws 58. The disc springs 59 provide a relatively light downward holding force on the transformer 51. This lightly mounts the transformer 51 on the bottom base chassis 50, which has an adequate strength to support it. The light downward holding force, and the slight oversize of the holes in the bottom base chassis 50, through which the screws 58 pass, permit vibrations generated when AC power is applied to the transformer 51 to move the transformer 51 slightly on the base chassis 50. Friction energy between the bottom of the case 54 and the bottom base chassis 50 substantially damps such vibrations to prevent transfer to other parts through the bottom base chassis 50 of the power amplifier 1.

The load on the disc springs 59 is set up to be proportional to the weight of the mounted electronic parts. Thus, harder disk springs 59 are selected for heavier parts. This allows vibrations to be converted into friction energy under similar conditions even if the weights of the electronic parts are different.

Also, since the case 54 filled with filler is attached to the bottom base chassis 50 rather than to the cover 57, the transformer 51 is attached to the bottom base chassis 50 in a stable manner. Furthermore, since the opening 26 formed on the cover 57 is positioned at the top, there is no need to have the transformer 51 elevated slightly from the bottom chassis 50 to allow wires 66 to be drawn out or to have an opening formed on the bottom chassis 50 to allow wires to be drawn out.

A center sleeve 3 is positioned above the power supply 2. The center sleeve is preferably formed from aluminum with a roughly rectangular cross section. Four substrates, to be described later, are disposed in the center sleeve 3. Four heat sinks 4 is disposed, one on each of the four outer surfaces of the center sleeve 3. Individual fins 23 of the heat sinks 4 are formed with different lengths to prevent resonance.

Referring to FIG. 10, the radially outer ends of the plurality of fins 23 of the heat sinks 4 are equidistant about a center O of a top plate 6 of the center sleeve 3 so that the ends of the four heat sinks 4 form a circle. Thus, the heat transferred first to a base 24 of each heat sink 4 is transferred outward on the plurality of fins 23 so that the heat is dissipated. As a result, the heat transfer characteristics do not vary greatly between the centers of the fins 23 and the ends of the fins 23. This provides efficient thermal dissipation.

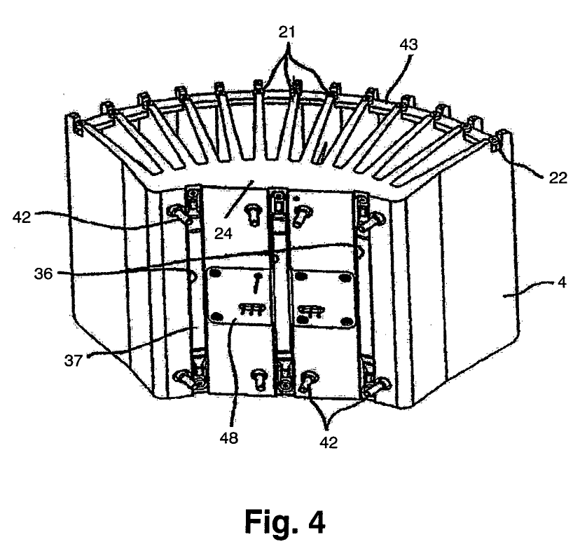

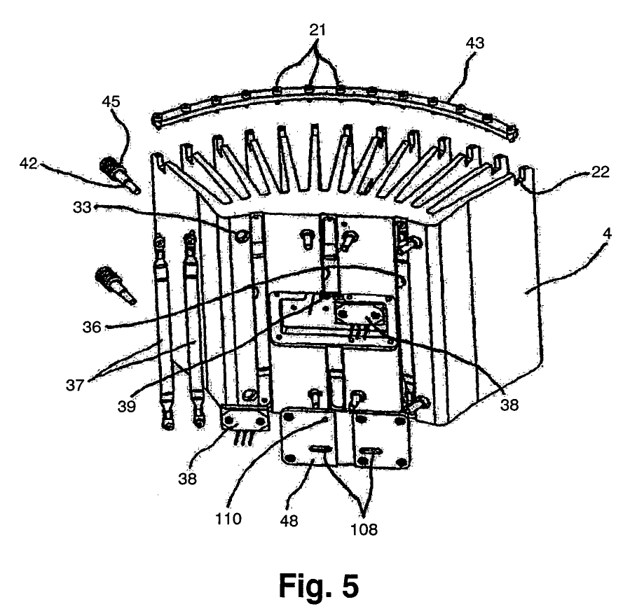

Referring now to FIGS. 4 and 5, two power transistors 38 are mounted on the base 24 of the heat sink 4. The two power transistors 38 are disposed equidistant from the center of the base and are arranged directly adjacent to each other laterally along the plane of FIG. 4. Thus, the two power transistors 38 are disposed equidistant from the center O of the top plate 6. As a result, the heat dissipation conditions of the power transistors 38 are roughly identical. This prevents variations in operating characteristics between the two when push-pull operations are being performed.

In this embodiment, the two power transistors 38 may be operated in a push-pull configuration, four power transistors 38 may be operated in a parallel push-pull configuration, eight power transistors 38 (two each on four heat sinks 4) may be operated in a BTL configuration. Thus, the operating characteristics of the power transistors 38 must be made as consistent as possible. The heat dissipation characteristics is made identical by using the same structure for the four heat sinks 4 and by using a layout where the power transistors 38 attached to each heat sink 4 are symmetrical to each other relative to the center line of the heat sink 4.

Also, the distances between the power transistors 38 and a power stage substrate 14, described later, to which the terminals of the power transistors 38 are connected, are kept roughly equal. This prevents discrepancies in operations caused by differences in distance.

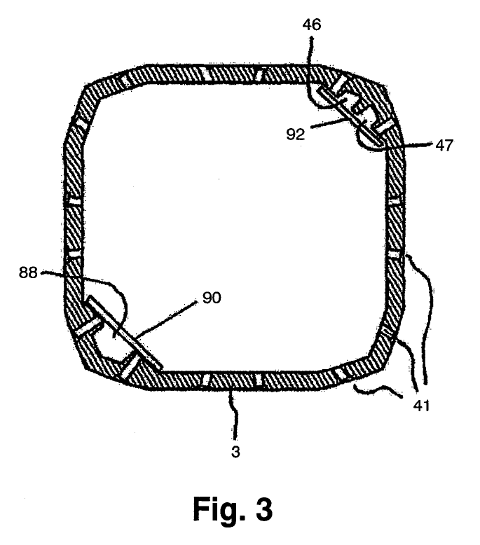

Referring to FIGS. 3, 4 and 5, openings 33 are formed in the heat sink 4 to allow the heat sink 4 to be attached to the center sleeve 3. The center sleeve 3 has threaded openings 41 which are aligned with the threaded openings 33. A coil spring 45 is interposed between a screw 42 and the heat sink 4. The compressive force of the coil spring 45 urges the heat sink 4 against the center sleeve 3 with a fixed pressure.

As with the transformer 51 described above, the heat sink 4 is not attached integrally to the center sleeve 3 by the screws 42. Thus, if the sound pressure from the speaker causes the heat sink 4 to vibrate, the heat sink 4 vibrates relative to the center sleeve 3. This vibration is absorbed as thermal energy, thus preventing the vibrations from being directly transferred to the sleeve 3.

The heat sink 4 is relatively large, with a height of approximately 20 cm and fin lengths of approximately 10 cm. Thus, it acts as a high-frequency antenna which could generate potential differences. If a potential difference is generated, current flows and creates a magnetic field which can influence the circuitry in the power amplifier 1 negatively. To prevent this, three parallel grooves 36 are formed vertically in the rear surface of the heat sink 4. Mesh wires 37, formed of copper mesh, with high conductivity are attached in these grooves. The mesh wires 37 are screwed to the upper and lower ends of the heat sink 4, thus forcibly short-circuiting the upper and lower ends of the heat sink 4 and preventing potential differences from being generated.

The two power transistors 38 and a thermistor 39, used to detect temperature, are attached to the back surface of the heat sink 4. These elements are shielded by a transistor cover plate 48. The terminals of the power transistors 38 and the temperature-detection thermistor 39 extend through openings 108, 110 on the transistor cover plate 48. These terminals are connected to a substrate, described later, in the center sleeve 3. An arcuate connecting bar 43 in each heat sink connects the tips of fins 23 together to prevent resonance in the heat sink 4. Connecting bars 43 are fitted into grooves near the tip of each fin 23. The connecting bars 43 are affixed using screws 21.

Referring again to FIG. 1, pin jack 5, used as an input terminal, and is disposed on the top plate 6 on the upper surface of the center sleeve 3. A speaker terminal 7, used as an output terminal, is disposed on a speaker terminal bracket 8 between the power supply 2 and the heat sink 4.

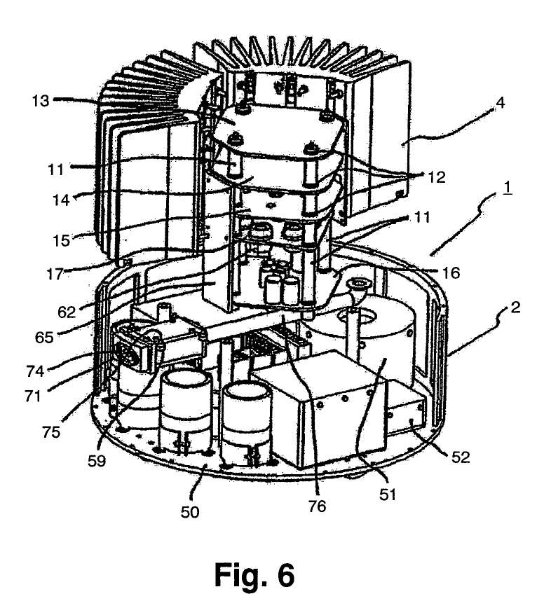

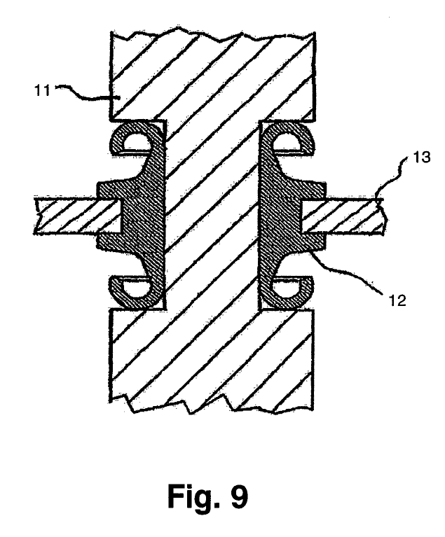

Referring to FIGS. 6 and 9, four shafts 11 are disposed parallel to each other in the center sleeve 3. Each shaft 11 has four rectangular grooves in its surface. Dampers 12 formed from silicone rubber are fitted into the rectangular grooves in the shafts 11. A groove at the center of each damper 12 receives the edge of a hole in one of the substrates. The substrates include a pre-amp substrate 13, a power-stage substrate 14, a servo stage substrate 15, and a low-power power supply substrate 16. These four substrates are supported parallel to each other. It will be noted that there is no rigid connection between the substrates and the shafts. Therefore, the dampers provide resilient support to their respective substrates, thereby reducing the transmission of vibration to the substrates.

The pre-amp substrate 13 provides preliminary amplification of a signal received from the pin jack 5. The pre-amp substrate 13 processes the input signal, which is the weakest signal. The pre-amp substrate 13 is positioned at the top, the furthest away from the power supply 2. This places the pre-amp substrate 13 the furthest away from the transformer 51, the choke coil 98, and other vibration and electrical interference generating elements in the power supply 2.

After pre-amplification in the pre-amp substrate 13, the input signal is applied to the power-stage substrate 14. The heat sink 4 to which the power transistors 38 are attached is attached to the center sleeve 3 by the coil springs 35, and the leads of the power transistor 38 are connected to the power stage substrate 14 via copper wires (not shown in the figure).

The amplifier in this embodiment performs class A amplification and controls the bias potential by detecting changes in collector current through temperature changes. The control circuitry used for this is provided in the servo-stage substrate 15 positioned below the power-stage substrate 14.

The low-power power supply substrate 16 contains components which rectify and smooth the power supply current received from the power supply 2. A ferrite beat support plate 17 and dampers 12 support the shafts 11 between the servo-stage substrate 15 and the low-power power supply substrate 16.

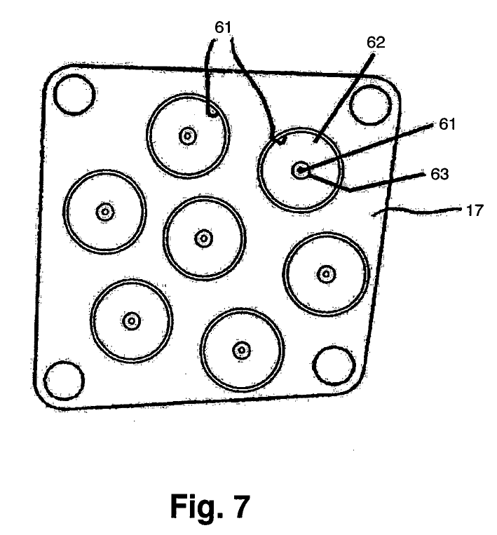

Referring now to FIG. 7, the ferrite bead support plate 17 is an aluminum plate with a total of six openings 61. Cylindrical ferrite beads 62, formed from ferrite, and used for high-frequency noise elimination are fitted in these openings 61 via tube-shaped dampers 63. All power supply lines from the power supply are passed through central openings 64 of the ferrite beads 62.

As is well known, ferrite material is substantially inert at the low frequencies common in power supplies, but tends to block higher frequencies. Thus, high-frequency noise in the feed lines to the substrates 13-16 is eliminated by the ferrite beads 62 fixed in the ferrite beads support plate 17 inside the power amplifier 1. This reduces the transmission of high-frequency interference in the feed lines. In addition, this reduces the effect of unavoidable variations that occur during the assembly of the power amplifier 1.

Noise from other stages must be prevented from affecting the output from the power stage substrate 14. Referring to FIG. 3, wires connecting the power stage substrate 14 and the speaker terminal 7 are disposed in a concave groove 88 formed at a corner of the inner surface of the center sleeve 3. Then, this concave groove 88 is sealed with an aluminum shield plate 90 to eliminate noise.

The pre-amp substrate 13 is positioned the furthest from the power supply 2. As a consequence, the power supply lines supplying power to the pre-amp substrate 13 are easily influenced by the other stages. To reduce noise, the wires supplying power to the pre-amp substrate 13 are passed through the ferrite beads 62 disposed on the ferrite beads support plate 17 and are then fitted into the concave groove 46 formed at the corner opposite from the concave groove 88. The wires are covered by the aluminum shield plate 90.

The wires used to transfer control signals from the servo stage substrate 15 to the pre-amp substrate 13 are fitted into a concave groove 47 adjacent the concave groove 46. The concave grooves 46, 47 are also covered with an aluminum shield plate 92.

As described above, the substrates 13-16 are separated into individual circuit stages and are arranged parallel to each other in the center sleeve 3. Thus, sound quality degradation that would occur in a single-substrate design due to cross-over in the power supply lines, the signal lines, and the servo signal lines is avoided.

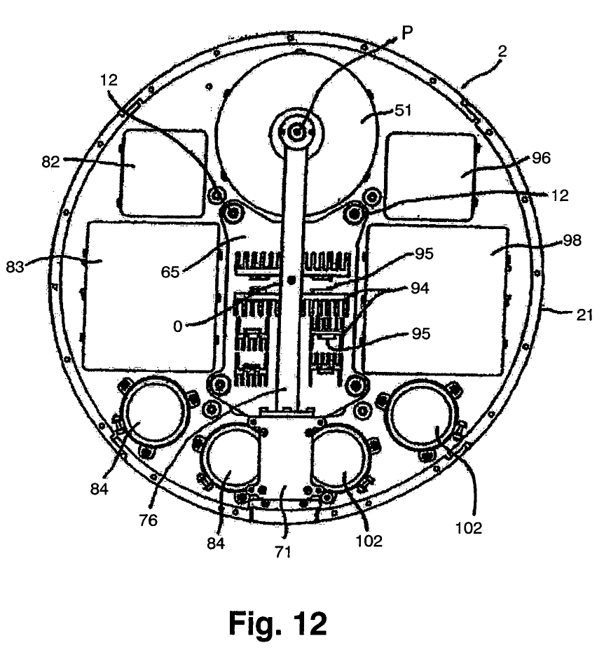

Referring to FIG. 12, the transformer 51 is a torroidal transformer used to convert 100-110 V alternating current potential into three different alternating current plus/minus potentials. The transformer 51 is placed on the opposite side of the power supply 2 from an AC connector block 71. Different AC currents are taken from the transformer 51, to be rectified by a diode substrate 65. Diodes 95 on the diode substrate 65 are attached to heat-dissipating heat sinks 94. The diode substrate 65 is supported via dampers 12 at the center of the power supply 2.

The rectified positive power supplies are sent, according to potential, to choke coils 96, 98, and 100 (not shown in the figure since they are below the diode substrate). Similarly, the rectified negative power supplies are sent, according to potential, to choke coils 82, 83, and 84 (not shown in the figure since they are below the diode substrate). Large smoothing capacitors 102, 84, which cannot be mounted on the low-power power supply substrate 16, are mounted in the power supply 2.

An AC line pipe is disposed along an imaginary line extending from the center O of the circular power supply 2 and a center P of the transformer 51. The choke coils 96, 82, the choke coils 98, 83, and the capacitors 102, 84 are laid out symmetrically relative to this imaginary line. Thus, the positive and negative power supplies are placed under the same conditions both electrically and mechanically so that a stable power supply is provided.

Also, by laying out the transformer 51, the choke coils 96, 82, the choke coils 98, 83, and the capacitors 102, 84 along an outer wall 21 of the circular power supply 2, a space is provided at the center for the diode substrate 65.

Also, by arranging the wires that can be affected by noise in the concave grooves 88, 46, 47 and sealing the concave grooves 88, 46, 47 using the shield plates 90, 92, the wires are shielded from noise. Since the wires are fixed in their positions, sound quality variations between individual units caused by variations in wire placement during manufacture is reduced.

With the widespread use of digital devices such as CD players, high-frequency noise is present around the power amplifier 1. The existence of such high frequencies may permit the transfer of noise to the surface of the power amplifier 1 by skin effect. High frequency noise transmitted in this way can infiltrate the power amplifier 1 along members such as cables and terminals that pass from the outside of the power amplifier 1 to the inside, thus reducing sound quality.

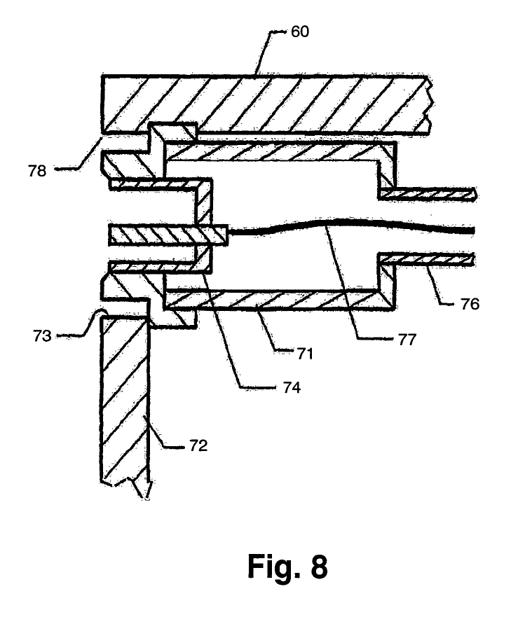

Referring now to FIG. 8, to prevent the infiltration of high-frequency noise, a box-shaped AC socket 74 is attached to AC connector block 71. A power supply plug attached to the end of a power supply cable is connected to the AC socket 74. A groove 78, of approximately 1 mm, is formed between the surface of the AC connector block 71 and a lower surface of a top base chassis, and between an upper surface of an opening 73 in an outer wall 72. High-frequency noise transferred along the surface of the outer wall 72 is prevented by the groove 78 from being transferred to the AC connector block 71. As a result, high-frequency noise is prevented from infiltrating the power amplifier 1 through the AC socket 74 attached to the AC connector block 71.

The AC connector block 71 is attached to a top base chassis 60 in the same manner as the attachment of case 54, shown in FIG. 2. That is, attachment may using the counterpart of a screw 58 and a disk spring 59 shown in FIG. 2. Thus, if the power supply cable vibrates due to sound pressure from the speaker or the like, the vibrations are transferred to the AC connector block 71 as well. However, the disk spring 59 prevents the vibrations from being transferred into the power amplifier 1.

Referring now to FIG. 1, in addition to the power supply cable described above, the cable connections in the power amplifier 1 include the pin jack 5 to which a pin cable is connected and the speaker terminal 7 to which the speaker cable is connected. These can be entry points for high-frequency noise flowing along the outer wall 72 of the power amplifier 1. Thus, as with the AC connector block 71 above, these connector terminals are attached to blocks formed as members separate from the outer wall 72. The surfaces of these members are separated by approximately 1 mm from the perimeter of openings formed on the outer wall 72, thus preventing infiltration of high-frequency noise transferred along the surface of the outer wall 72. These blocks are attached to the chassis 50 via disk springs so that mechanical vibrations from the pin cable and the speaker cable are prevented from direct transfer into the power amplifier 1.

Referring again to FIG. 8, the AC socket 74 is connected to a power supply switch (not shown in the figure) positioned on the opposite side using a wire 77. The wire 77 is disposed inside an aluminum AC line pipe 76 between the AC connector block 71 and the power supply switch, thus preventing high-frequency noise in the power supply line from radiating into the power supply 2.

A cable support 9 (FIG. 10) supports a pin cable (not shown in the figure) connected to the pin jack 5 to hold the pin cable out of into contact with the heat sink 4.

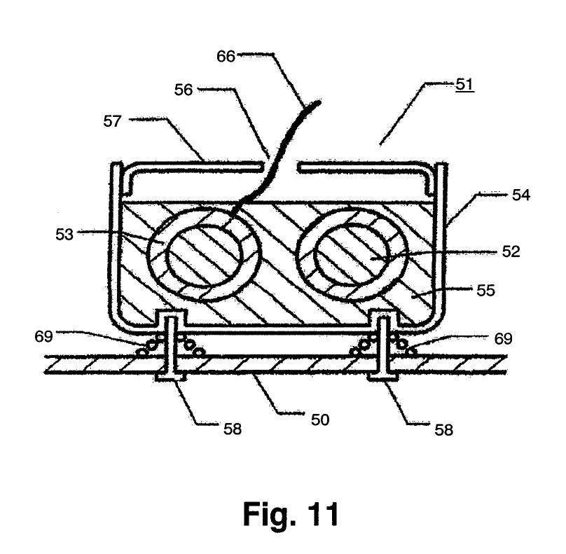

In the embodiment described above, the transformer 51 is attached to the bottom base chassis 50 via disk springs 59. However, the present invention is not restricted to this. Any convenient type of elastic body having a spring constant appropriate for the weight of the electronic parts to be supported may be used. Referring to the embodiment in FIG. 11, for example, conical coil springs 69 are used apply a small downward force on the transformer 51, as. In this case, the shape of the conical springs 69 permits substantial compression without the coils bumping into each other. Thus, the conical spring 69 may be compressed almost down to its wire diameter without coil-to-coil contact. This permits the use of a conical coil spring 69 which is considerably shorter than would be required if a helical coil spring were used.

In the present invention as described above, a plurality of circuit substrates are disposed parallel to each other, allowing individual circuit stages to be separated by substrates to provide spatial separation. Substrates processing low-power signals are placed on substrates furthest from the power supply to give minimum influence of magnetic fields and vibration from the power supply on the low-power signals. Extraneous high-frequency electrical noise from the power supply, and mechanical vibration from the power supply and the speaker, are isolated from affecting other elements, thus providing an amplifier with superior sound quality.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention as defined in the appended claims.

What is claimed is:

1. An acoustic device comprising:
a case;
a plurality of substrates disposed in said case; and
said plurality of substrates being disposed substantially aligned vertically and roughly parallel to each other.

2. An acoustic device according to claim 1, further comprising:
a heat sink attached to said case;
said heat sink including a base;
said heat sink further including a plurality of fins affixed to said base and extending outward for dissipating heat to the environment; and
a heat-generating amplifying element attached to said base, whereby heat generated in said amplifying element is conducted outward through said base to said plurality of fins.

3. An acoustic device as described in claim 1 wherein:
said case is affixed to a power supply; and
said power supply includes at least a transformer.

4. An acoustic device as described in claim 3 wherein:
a one of said substrates performing amplification on the smallest acoustic signal is positioned furthest from said power supply.

5. An acoustic device according to claim 3, wherein said plurality of substrates are resiliently supported in said case, whereby mechanical vibration in said case is isolated from said plurality of substrates.

6. An acoustic device according to claim 5, wherein each of said plurality of substrates is resiliently supported independently of a remainder thereof.

7. An acoustic device comprising:
a housing;
a circuit element mounted in said housing;
a case on said circuit element;
a cover covering a top of said case; and
an opening disposed on said cover and through which wire passes for connection of said circuit element to other elements in said acoustic device.

8. An acoustic device according to claim 7, further comprising:
an attachment member; and
said attachment member attaching a bottom of said case to said housing.

9. An acoustic device according to claim 8, wherein:
said circuit element is a transformer; and
said attachment member includes a resilient element for resiliently attaching said bottom of said case to said housing, whereby vibration from said transformer is isolated from a remainder of said acoustic device.

10. An acoustic device according to claim 9, wherein said transformer is a toroidal transformer.

11. An acoustic device as described in claim 9, wherein:
said transformer includes at least one winding in said case;
a filler in said case;
said filler occupying an interior of said case about said at least one winding and securing and supporting said at least one winding in said case.

12. An acoustic device comprising:
at least one connecting member disposed at an outer surface of said acoustic device for providing electrical connection with another device; and
a groove formed to a predetermined depth about a perimeter of said connecting member at said outer surface; and
a width and depth of said groove being effective for blocking entry of electrical interference into an interior of said acoustic device.

13. An acoustic device according to claim 12, wherein:
said at least one connecting member includes a plurality of connecting members; and
each of said plurality of connecting members includes a groove about its perimeter for blocking the entry of electrical interference through any thereof into said interior.

14. An acoustic device as described in claim 12 further comprising:
an attachment member supporting said connecting member;
said attachment member being independent of said wherein said connecting member is attached to an attachment member formed as a separate member from a case of said acoustic device; and
resilient means for affixing said attachment member to said case, whereby mechanical vibration is blocked from entering said acoustic device through said connecting member.

15. An acoustic device as described in claim 14 wherein said resilient means includes an elastic member interposed between said attachment member and said case so that said attachment member is attached with a fixed pressure to said case.

16. An acoustic device comprising:
a groove formed on the inside of an acoustic device case;
at least one wire disposed inside said groove; and
a cover covering said groove, whereby induction of interference into said at least one wire is prevented.

17. An acoustic device comprising:
a hollow pipe disposed inside an acoustic device case; and
at least one wire disposed in said pipe.

18. An acoustic device comprising:
a heat sink;
said heat sink including a base;
at least one power amplifier element affixed to said base; and
a plurality of fins extending roughly radially from said base.

19. An acoustic device according to claim 18, further comprising:
a connection between adjacent tips of said fins to prevent vibration thereof.

20. An acoustic device according to claim 18, wherein at least some of said plurality of fins have different dimensions from a remainder thereof, whereby resonance of said plurality of fins is prevented.

21. An acoustic device according to claim 20, wherein said dimensions are lengths.

22. An acoustic device as described in claim 18 wherein ends of said plurality of fins roughly lie along an arc centered on a point.

23. An acoustic device as described in claim 22 wherein:
said at least one power amplifier element includes a plurality of semiconductor elements attached to said heat sink; and
said semiconductor elements are disposed roughly equidistant from said point.

24. An acoustic device according to claim 18, wherein:
said heat sink includes a plurality of heat sink modules;
said heat sink modules being assembled with tips of said fins directed outward; and
at least one power amplifier element affixed to a base of each of said heat sink modules.

25. An acoustic device according to claim 24, wherein said power amplifier elements are distributed generally symmetrically about a central axis of said heat sink.

26. An acoustic device according to claim 24, further comprising:
a center sleeve in said acoustic device; and
each of said heat sink modules being resiliently and independently affixed to an exterior of said center sleeve.

27. An acoustic device comprising:
an electronic part that vibrates when powered is applied thereto;
said electronic part being attached to said electronic device via an elastic member to absorb vibration from said electronic part; and
said elastic member having an elasticity appropriate to a weight of said electronic part.

28. An acoustic device as described in claim 27 wherein said electronic part is a transformer.

29. An acoustic device comprising:
a power supply;
said power supply being substantially circular;
a transformer in said power supply;
a smoothing capacitor in said power supply; and
said transformer and said smoothing capacitor are disposed along an outer perimeter of said substantially circular power supply.

30. An acoustic device according to claim 29, wherein:
said transformer and said smoothing capacitor are distributed inside an outer perimeter of said power supply;
positioning of said transformer and said smoothing capacitor being generally symmetrical from a weight standpoint.

31. A power supply for an acoustic device comprising:
said power supply being substantially circular;
positive power supply parts for a positive power supply;
negative power supply parts for a negative power supply;
a power transformer;
said positive power supply parts, said negative power supply parts, and said transformer are disposed symmetrically relative to an imaginary line forming a central axis of said substantially circular power supply.

32. A power supply according to claim 31, wherein distribution of said power supply parts is generally symmetrical from a weight standpoint.
